(19) United States
(12) Patent Application Publication
(10) Pub. No.: US 2007/0160378 A1
(43) Pub. Date: Jul. 12, 2007

(54) IMAGE FORMING APPARATUS, CHARGING PROCESS APPARATUS, AND IMAGE FORMING SYSTEM

(75) Inventor: Yoshihiro MATSUDA, Minato-ku, Tokyo (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: OKI DATA CORPORATION, Tokyo (JP)

(21) Appl. No.: 11/621,165

(22) Filed: Jan. 9, 2007

(30) Foreign Application Priority Data
Jan. 11, 2006 (JP) 2006-003812

(51) Int. Cl. G03G 21/02

(52) U.S. Cl. 399/79

(57) ABSTRACT

This invention enables users of image forming apparatuses to be charged fairly by preventing the users from being charged for consumable supply usage consumed because of a reason that the user is not responsible for such as paper jamming. The image forming system according to this invention includes an image forming apparatus for collecting a usage amount of consumable supply consumed by a printing process for each requesting source of the printing process, wherein the image forming apparatus has an event recognition unit for interrupting the printing process upon detecting a prescribed condition during the printing process and a charging information collection unit for collecting a usage amount of the consumable supply consumed by the printing process interrupted by the event recognition unit, and a charging process apparatus having an input unit for receiving from the image forming apparatus a first consumable supply usage amount consumed by the printing process and a second consumable supply usage amount consumed by the printing process interrupted and a charging calculation unit for calculating charging amounts based on the first consumable supply usage amount and the second consumable supply usage amount received from the input unit.

### BACKGROUND OF THE INVENTION

This invention relates to an image forming apparatus for collecting usage amounts of consumable supplies for each requesting source of printing process, a charging process apparatus for calculating charging amounts for each requesting source of the printing process based on the collected result of usage amounts, and an image forming system including both the image forming apparatus and the charging process apparatus.

Recently, there are many cases in which an image forming apparatus is connected to a prescribed network and shared by multiple user computers connected to the network. In such network environment, it is necessary that usage amounts of consumable supplies be fairly allotted to the multiple user computers. To achieve this purpose, technologies for various charging systems of consumable supplies have been developed, such as, e.g., Japanese Patent Application Publication No. 2002-149020. In this prior art, charging amounts of each user computer are determined based on actually consumed amounts of consumable supplies for printing.

For example, in a case that a print job with multiple sheets is performed and a paper jamming occurs in the midway through printing sheets, the number of print media wasted due to the paper jamming is unfavorably included in the actually consumed amount of the consumable supply for printing. However, a user is not responsible for such paper jamming. In such a case, consumable supply expenses may not be fairly allotted if expenses for consumable supplies wasted due to the paper jamming are charged to users.

This invention seeks to solve such problems associated with the prior art that users are made to bear even costs of consumable supplies that the users are not responsible for such as jammed papers.

### BRIEF SUMMARY OF THE INVENTION

This invention relates to an image forming system including an image forming apparatus for collecting a usage amount of a consumable supply consumed by a printing process for each requesting source of the printing process, wherein the image forming apparatus has an event recognition unit for interrupting the printing process upon detecting a prescribed condition during the printing process and a charging information collection unit for collecting a usage amount of the consumable supply consumed by the printing process interrupted by the event recognition unit, and a charging process apparatus having an input unit for receiving from the image forming apparatus a first consumable supply usage amount consumed by the printing process and a second consumable supply usage amount consumed by the printing process interrupted and a charging calculation unit for calculating a charging amount based on the first consumable supply usage amount and the second consumable supply usage amount received from the input unit.

This invention is advantageous in allowing users to be charged fairly, because the charging is performed upon determining whether a user is responsible for a consummation of consumable supplies.

The event recognition unit and the charging information collection unit are realized with only modification in the control program stored in the ROM in the image forming apparatus.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood however, that the invention is not limited to the precise arrangement and instrumentalities shown.

In the drawings,

FIG. 1 is a system configuration diagram showing an image forming system according to this invention;

FIG. 2 is a block diagram showing a configuration of a user computer according to the first embodiment of to this invention;

FIG. 3 is a block diagram showing a configuration of an image forming apparatus according to the first embodiment of this invention;

FIG. 4 is a block diagram showing a charging server according to the first embodiment of this invention;

FIG. 5 is an explanatory diagram showing an example of a charging accumulation table according to the first embodiment of this invention;

FIG. 6 is a flowchart showing an operation of the user computers according to the first embodiment of this invention;

FIG. 7 is a flowchart showing an operation of the charging server according to the first embodiment of this invention;

FIG. 8 is a flowchart showing an operation of the image forming apparatus according to the first embodiment of this invention;

FIG. 9 is a block diagram showing a configuration of the user computers according to the second embodiment of this invention;

FIG. 10 is a block diagram showing a configuration of the image forming apparatus according to the second embodiment of this invention;

FIG. 11 is a block diagram showing a configuration of the charging server according to the second embodiment of this invention;

FIG. 12 is an explanatory diagram showing an example of the charging accumulation table according to the second embodiment of this invention;

FIG. 13 is a flowchart showing an operation of the user computers according to the second embodiment of this invention;

FIG. 14 is part 1 of a flowchart showing an operation of the image forming apparatus according to the second embodiment of this invention; and

FIG. 15 is part 2 of a flowchart showing an operation of the image forming apparatus according to the second embodiment of this invention.

### DETAILED DESCRIPTION OF THE INVENTION

Particular embodiments according to this invention is hereinafter described in detail with reference to the figures.

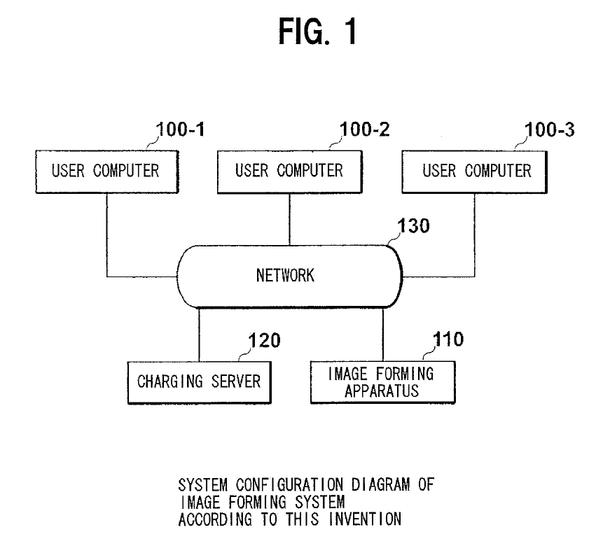

FIG. 1 is a system configuration diagram showing an image forming system according to this invention. As shown in FIG. 1, the image forming system according to this invention includes a plurality of user computers 100-1, 100-2, and 100-3 (The number of sets thereof is herewith limited to three as an example), an image forming apparatus 110, and a charging server 120, all of which are connected to a network 130. The network 130 can be any type of network, such as, e.g., as a matter of course, LAN (Local Area Network) such as Ethernet (registered trademark of Xerox Corporation), provided that the prescribed image forming apparatus 110 can be commonly used by the multiple user computers 100-1, 100-2, and 100-3. A configuration of the user computer 100, the image forming apparatus 110, and the charging server 120 is hereinafter respectively described in detail.

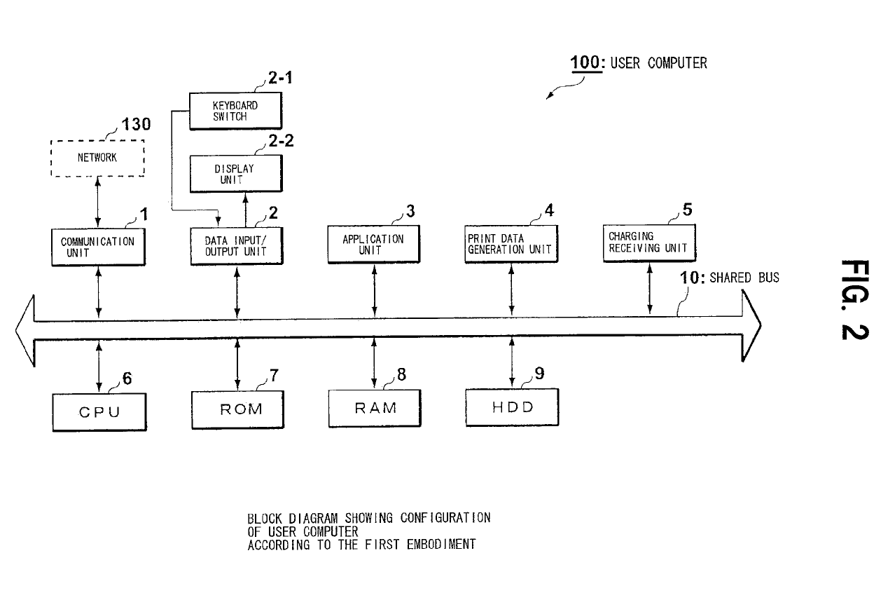

FIG. 2 is a block diagram showing a configuration of the user computers according to the first embodiment. As shown in FIG. 2, the user computer 100 according to the first embodiment includes a communication unit 1, a data input/output unit 2, an application unit 3, a print data generation unit 4, a charging receiving unit 5, a CPU 6, a ROM 7, a RAM 8, a HDD 9, and a shared bus 10. The user computer 100 is an apparatus with which a user inputs prescribed print information and which receives charging amounts of consumable supplies consumed or wasted upon printing the print information input by the user so as to notify the user of the charging amount. The user computer 100 is usually a personal computer.

The communication unit 1 communicatively connects the user computer 100 with the network 130 based on a prescribed protocol, thus acting as a network interface between the user computer 100 and the network 130.

The data input/output unit 2 includes a keyboard switch 2-1 and a display unit 2-2, and is a unit with which the user inputs the print information or which notifies the user of various information such as control information and the charging amount, thus acting as a man-machine interface between the user and the user computer 100.

The application unit 3 generates text data (including texts and graphics). Print data according to various image forming apparatuses are generated based on the text data. This performance is realized with the CPU 6 extracting to the RAM 8 an application program previously stored in the ROM 7 or the HDD 9 and executing the program.

The print data generation unit 4 generates the print data (namely, image data) based on the text data generated by the application unit 3. This performance is realized with the CPU 6 extracting to the RAM 8 an application program previously stored in the ROM 7 or the HDD 9 and executing the program.

Upon finishing printing a set of print request (a print job) input by the user, the charging receiving unit 5 receives, via the network 130 from the charging server 120 (FIG. 1), the charging amount of consumable supplies consumed by printing of the print job or a successive series of print jobs and notifies the user of the charging amount thereof with the display unit 2-2. This performance is realized with the CPU 6 extracting to the RAM 8 an application program previously stored in the ROM 7 or the HDD 9 and executing the program.

The CPU 6 is a microprocessor for controlling the entire apparatus, and more particularly in the first embodiment, the CPU 6 not only initiates but also executes the application unit 3, the print data generation unit 4, and the charging receiving unit 5 by executing a control program previously stored in the ROM 7 or the HDD 9.

The ROM 7 is a read-only memory previously storing the control program for controlling the entire apparatus, and more particularly in the first embodiment, the ROM 7 is a read-only memory previously storing the control program that the CPU 6 executes for initiating the application unit 3, the print data generation unit 4, and the charging receiving unit 5.

The RAM 8 is a random access memory for providing a calculation area for the CPU 6 executing the control program. The HDD 9 is a hard disk previously storing the application program and the control program for controlling the entire apparatus, and more particularly in the first embodiment, the HDD 9 is a hard disk previously storing the application program or the control program that the CPU 6 executes for initiating the application unit 3, the print data generation unit 4, and the charging receiving unit 5. The shared bus 10 is a signal line for communicatively connecting units inside the apparatus with each other.

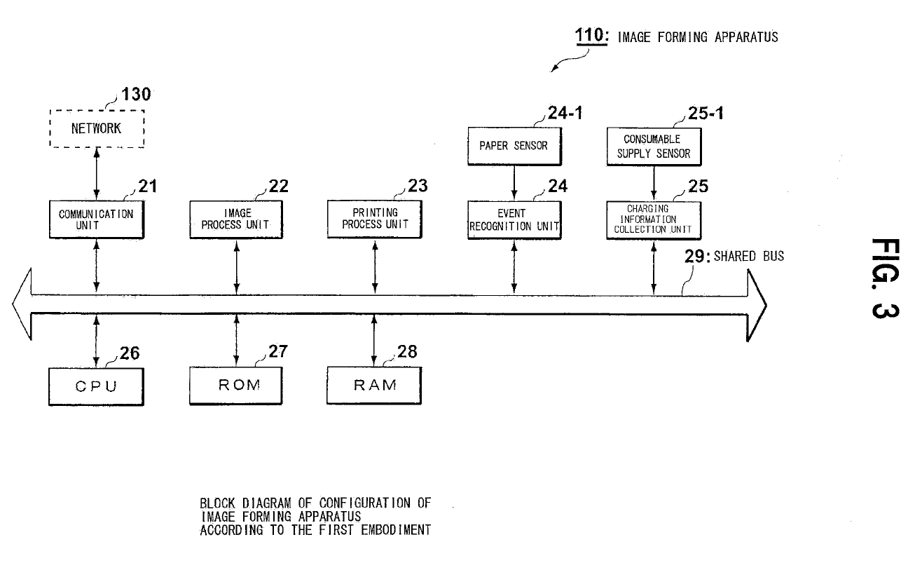

FIG. 3 is a block diagram showing a configuration of the image forming apparatus according to the first embodiment. As shown in FIG. 3, the image forming apparatus 110 according to the first embodiment includes a communication unit 21, an image process unit 22, a printing process unit 23, an event recognition unit 24, a charging information collection unit 25, a CPU 26, a ROM 27, a RAM 28, and a shared bus 29, and is a printing apparatus that not only performs a printing process upon receiving print data based on the print information which the user inputs with the user computers 100-1 through 100-3 but also collects and notifies the charging server 120 (FIG. 1) of usage amounts and types of consumable supplies consumed by printing the print data.

The communication unit 21 communicatively connects the image forming apparatus 110 with the network 130 based on the prescribed protocol, and acts as a network interface between the image forming apparatus 110 and the network 130.

The image process unit 22 extends into bitmap data the print data received from the user computers 100-1 through 100-3 via the network. This performance is realized with the CPU 26 executing the control program previously stored in the ROM 27.

The printing process unit 23 is a print engine that receives the bitmap data extended by the image process unit 22 and performs multicolor or monochrome image printing on a print medium of a prescribed size based on a request of the user via the user computers 100-1 through 100-3. An event recognition sensor 24-1 (paper sensor) and a consumable supply sensor 25-1 are arranged at prescribed positions of the printing process unit 23. The event recognition sensor 24-1 is needed by the event recognition unit 24 to recognize an event such as paper jamming. The consumable supply sensor 25-1 notifies the charging information collection unit 25 of the usage amounts and types of the consumable supplies.

The event recognition unit 24 interrupts an operation of the printing process unit 23 when recognizing an event such as paper jamming based on, e.g., location information of the print medium received from the paper sensor 24-1 arranged at the prescribed position of the printing process unit 23 during the printing process for the set of print request (the print job) received from any one of the user computers 100-1 through 100-3. This performance is realized with the CPU 26 executing the control program previously stored in the ROM 27.

The charging information collection unit 25 receives the usage amounts and types of consumable supplies consumed by the printing process from the consumable supply sensor arranged at the prescribed position of the printing process unit 23 to collect charging information and notifies the charging server 120 (FIG. 1) thereof via the network, when the printing process for the set of print request (the print job or the successive series of print jobs) received from any one of the user computers 100-1 through 100-3 has been either finished or interrupted. The consumable supply sensor herein detects, for example, usage amounts and types of recording media and developing agents (toners and inks). This performance is realized with the CPU 26 executing the control program previously stored in the ROM 27.

The CPU 26 is a microprocessor for controlling the entire apparatus, and more particularly in the first embodiment, realizes functions of the image process unit 22, the event recognition unit 24, and the charging information collection unit 25 by executing the control program previously stored in the ROM 27.

The ROM 27 is a read-only memory previously storing the control program for controlling the entire apparatus, and more particularly in the first embodiment, the ROM 27 is a read-only memory previously storing the control program that the CPU 26 executes for the image process unit 22, the event recognition unit 24, and the charging information collection unit 25.

The RAM 28 is a random access memory for providing a calculation area for the CPU 26 executing the control program, namely, for example, an area necessary for extracting bitmap data. The shared bus 29 is a signal line for communicatively connecting units inside the apparatus with each other.

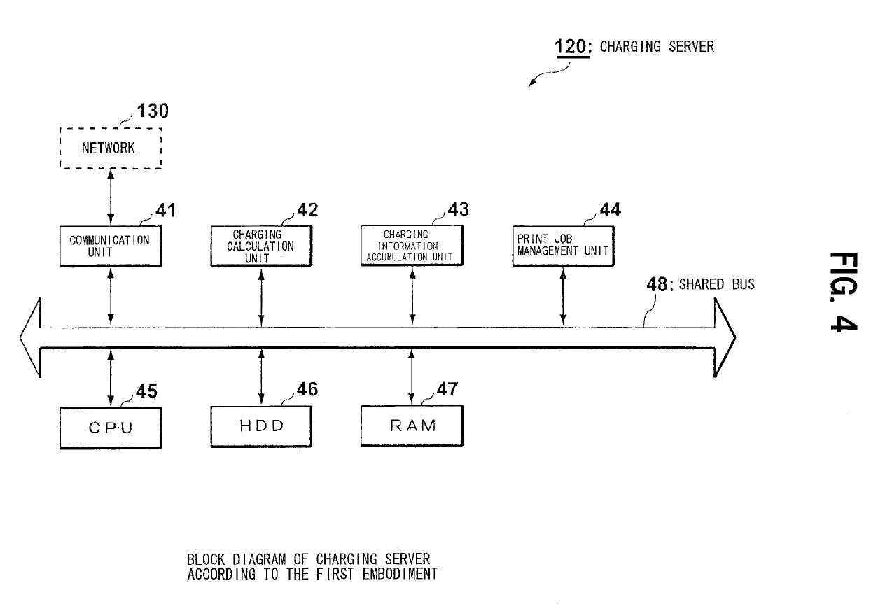

FIG. 4 is a block diagram showing a configuration of the charging server according to the first embodiment. As shown in FIG. 4, the charging server 120 according to the first embodiment includes a communication unit 41 serving as an input unit, a charging calculation unit 42, a charging information accumulation unit 43, a print job management unit 44, a CPU 45, a HDD 46, a RAM 47, and a shared bus 48. The charging server 120 is a server through which the user transmits the print data to the image forming apparatus 110 (FIG. 1) from the user computers 100-1 through 100-3 and which collects from the image forming apparatus 110 (FIG. 1) an accumulated result of usage amounts and types of consumable supplies consumed by printing the print data so as to notify the user computers 100-1 through 100-3 of calculated charging amounts, respectively.

The communication unit 41 communicatively connects the charging server 120 with the network 130 based on the prescribed protocol, and acts as a network interface between the charging server 120 and the network 130.

The charging calculation unit 42 receives from the image forming apparatus 110 (FIG. 1) the accumulated result of usage amounts and types of consumable supplies consumed by printing the set of print data and calculates the charging amount, where the printing process for the set of print request (the print job) has been either finished or interrupted. This performance is realized with the CPU 45 transferring the control program previously stored in the HDD 46 to the RAM 47 and executing the program.

The charging information accumulation unit 43 accumulates in the charging accumulation table, for each user computer respectively, charging amounts calculated by the charging calculation unit 42 for each print data input by the user via the user computers 100-1 through 100-3. This performance is realized with the CPU 45 transferring the control program previously stored in the HDD 46 to the RAM 47 and executing the program. An example of a charging accumulation table is described below.

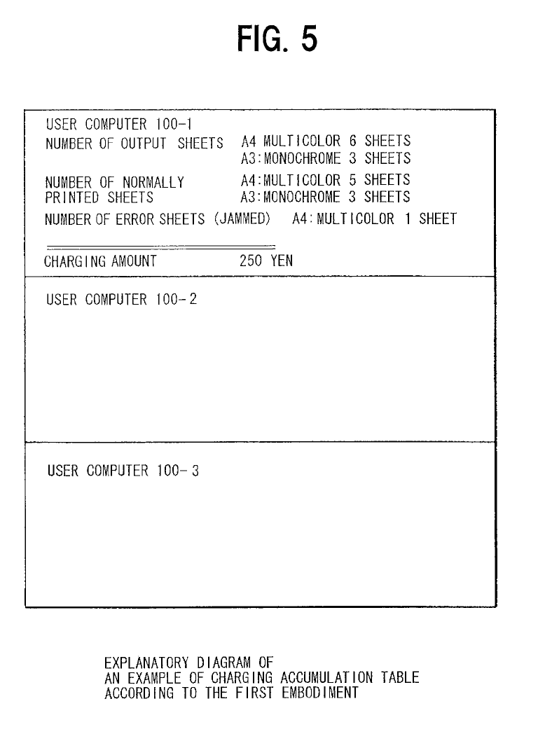

FIG. 5 is an explanatory diagram showing the example of the charging accumulation table according to the first embodiment. FIG. 5 shows the accumulated result displayed, namely, the number of output sheets, the number of normally printed sheets, the number of error sheets, and a calculated charging amount for each user computer. Information within a frame for each user computer in the table is revised when the printing process for the set of print request (the print job) received from the user computer has been either finished or interrupted.

Referring back to FIG. 4, the print job management unit 44 is a unit through which the user transmits the print data from the user computers 100-1 through 100-3 to the image forming apparatus 110 (FIG. 1) and which manages the print data (the print job), that is, e.g., determining whether the set of the print data includes only a single print job or a successive series of multiple print jobs and determining a printing sequence of the print jobs. This performance is realized with the CPU 45 executing the control program previously stored in the HDD 46.

The CPU 45 is a microprocessor for controlling the entire apparatus, and more particularly in the first embodiment, the CPU 45 initiates the charging calculation unit 42, the charging information accumulation unit 43, and the print job management unit 44 by executing a control program previously stored in a HDD 46.

The HDD 46 is a hard disk previously stores the control program to control the entire apparatus, and more particularly in the first embodiment, the HDD 46 previously stores the control program that the CPU 45 executes for realizing the charging calculation unit 42 and the charging information accumulation unit 43.

The RAM 47 is a random access memory to which the control program stored in the HDD 46 is delivered and where the CPU 45 executes the control program. The RAM 47 provides a calculation area for the CPU 45 executing the control program, namely, e.g., an area for the charging accumulation table generated by the charging information accumulation unit 43. The shared bus 48 is a signal line for communicatively connecting units inside the apparatus with each other.

An operation of the first embodiment is hereinafter described in detail. First, operation of the user computer 100 (FIG. 2) is described, and subsequently an operation of the charging server 120 (FIG. 4) and the image forming apparatus 110 (FIG. 3) is described.

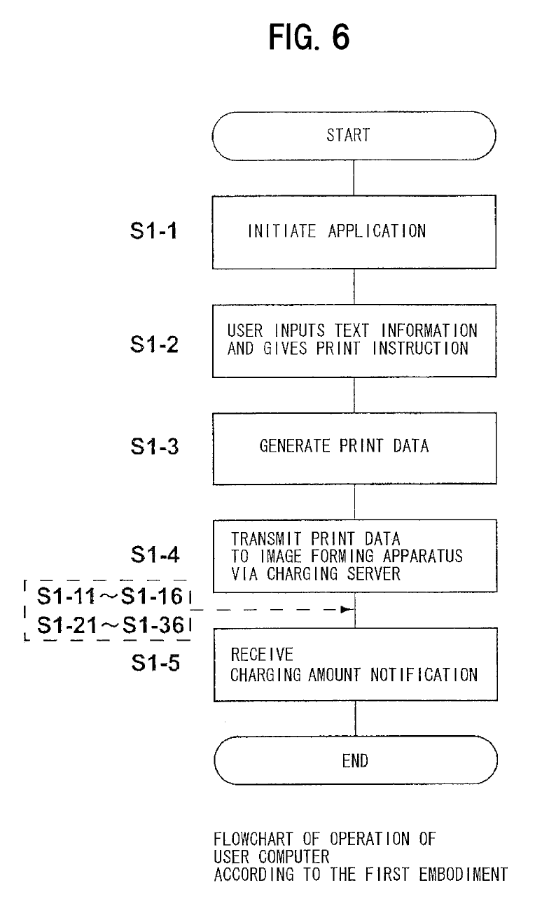

FIG. 6 is a flowchart showing an operation of the user computer according to the first embodiment. An operation of the user computers for steps S1-1 through S1-5 is hereinafter described in a sequence of steps.

In step S1-1, the user initiates the application unit 30 (FIG. 1) by the use of the keyboard switch 2-1 (FIG. 2) and the display unit 2-2 (FIG. 2).

In step S1-2, the user generates text information in the application unit 30 (FIG. 1) by the use of the keyboard switch 2-1 (FIG. 2) and the display unit 2-2 (FIG. 2), and gives a print instruction of the generated text information.

In step S1-3, the print data generation unit 4 generates the print data according to each image forming apparatus from the text information generated by the application unit 30 (FIG. 1).

In step S1-4, the communication unit 1 (FIG. 2) transmits the print data generated by the print data generation unit 4 through the network via the charging server 120 (FIG. 1) to the image forming apparatus 110 (FIG. 1).

In step S1-5, the charging receiving unit 5 (FIG. 2) terminates this flow upon receiving a charging amount notification from the charging server 120 (FIG. 1) and notifying the user of the charging amount with the display unit 2-2 (FIG. 2) after steps S1-11 through S1-16 and steps S1-21 through S1-36 have been performed, which will be described below.

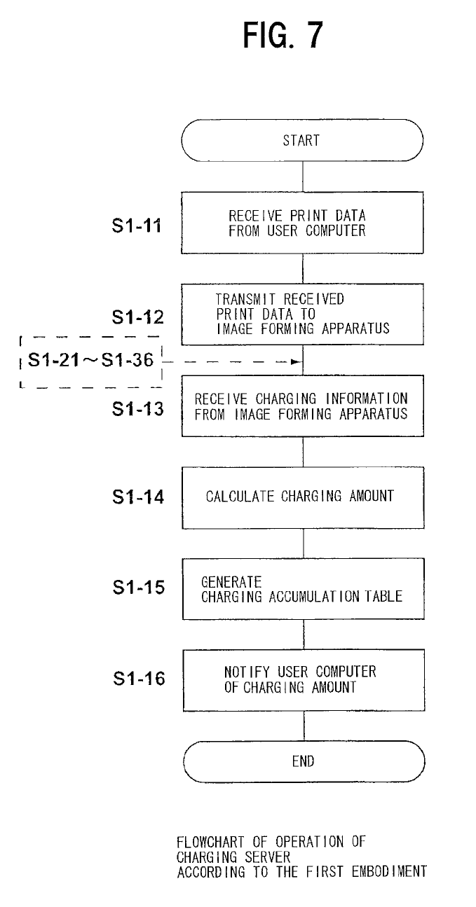

FIG. 7 is a flowchart showing an operation of the charging server according to the first embodiment. An operation of the charging server 120 (FIG. 4) for steps S1-11 through S1-16 is hereinafter described.

In step S1-1, the print job management unit 44 (FIG. 4) receives the print data via the communication unit 41 (FIG. 4) from the user computers 100-1 through 100-3.

In step S1-12, the print job management unit 44 (FIG. 4) manages the set of print data (the print job) transmitted from each user, determines the number of sheets of each print data, determines a printing sequence, and transmits the print data via the communication unit 41 (FIG. 4) to the image forming apparatus 110 (FIG. 1) according to the determined printing sequence.

In step S1-13, the communication unit 41 (FIG. 4) receives the accumulated result of usage amounts and types of consumable supplies consumed by printing the print data transmitted from the image forming apparatus 110 (FIG. 1) and transmits the accumulated result to the charging calculation unit 42, after having performed steps S1-21 through S1-36.

In step S1-14, the charging calculation unit 42 (FIG. 4) calculates the charging amount (the charging information) based on the accumulated result of usage amounts and types of consumable supplies. For example, in a case that the user requests a print job of ten sheets of A4 size and a print job of three sheets of A3 size, and that paper jamming occurs at sixth sheet of A4 size, resulting in five sheets of A4 size and three sheets of A3 size as a final output, the charging amount is calculated as follows.
The charging amount (Yen)=20(Yen)×5(Sheets)+50(Yen)×3(Sheets)=250(Yen)
Please note that a sheet of A4 size wasted due to an unfavorable phenomenon (paper jamming) is deleted from six sheets of A4 size and three sheets of A3 size consumed by the printing process.

In step S1-15, the charging information accumulation unit 43 (FIG. 4) accumulates in the charging accumulation table (FIG. 5) formed in the RAM 47 (FIG. 4), for each user computer respectively, accumulated results of usage amounts and types of consumable supplies consumed by printing the print data input from the user computers 100-1 through 100-3 and the charging amounts calculated by the charging calculation unit 42 (FIG. 4).

In step S1-16, the charging information accumulation unit 43 (FIG. 4) terminates this flow upon notifying the user computers 100-1 through 100-3 (FIG. 1) of a content of the charging accumulation table (FIG. 5) via the communication unit 41 (FIG. 4) through the network 130 (FIG. 4).

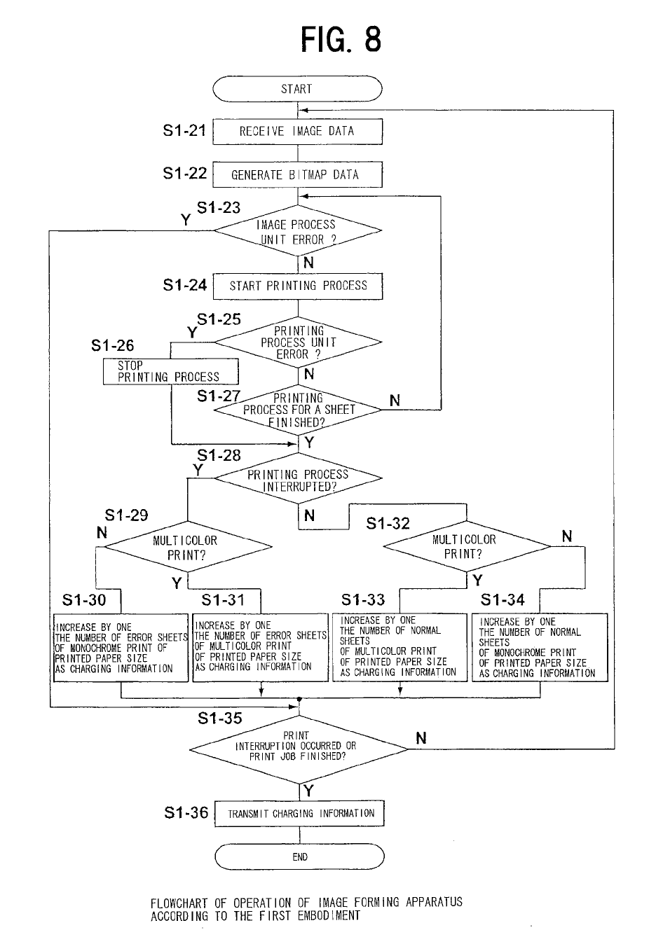

FIG. 8 is a flowchart showing an operation of the image forming apparatus according to the first embodiment. An operation of the image forming apparatus 110 (FIG. 3) for steps S1-21 through S1-36 is hereinafter described in a sequence of steps.

In step S1-21, the communication unit 21 (FIG. 3) receives the print data from the user computers 100-1 through 100-3 (FIG. 1) through the network via the charging server 120 (FIG. 1).

In step S1-22, the image process unit 22 (FIG. 3) receives the print data from the communication unit 21 (FIG. 3) and extends the print data into bitmap data in the RAM 28 (FIG. 3).

In step S1-23, where an image process unit error occurs, namely, e.g., a control code that the image process unit 22 cannot interpret is included, the process of print job is terminated here, and it is proceeded to step S1-35. Where no image process unit error occurs, it is proceeded to step S1-24.

In step S1-24, the printing process unit 23 (FIG. 3) receives bitmap data from the RAM 28 (FIG. 3) and starts printing process.

In step S1-25, the event recognition unit 24 (FIG. 3) determines whether paper jamming (a printing process unit error) is occurring based on location information of the print medium received from the paper sensor 24-1 (FIG. 3) arranged at the prescribed position of the printing process unit 23 (FIG. 3). Where the paper jamming occurs, it is proceeded to step S1-26. Where it does not occur, it is proceeded to step S1-27.

In step S1-26, the event recognition unit 24 (FIG. 3) interrupts the printing process and proceeds to S1-28.

In step S1-27, the printing process unit 23 (FIG. 3) repeats steps S1-23 through S1-27 until a sheet is printed, and proceeds to step S1-28 upon finishing printing a sheet.

In step S1-28, the charging information collection unit 25 (FIG. 3) proceeds to step S1-29 where the printing process is interrupted, namely, step S1-26 has been performed, and proceeds to step S1-32 where the printing process has finished printing a sheet, namely, step S1-27 has been performed.

In step S1-29, the charging information collection unit 25 (FIG. 3) determines whether the printing process is multicolor. In a case of multicolor print, it is proceeded to step S1-31. In a case of monochrome print, it is proceeded to step S1-30.

In step S1-30, the charging information collection unit 25 (FIG. 3) increases by one the number of error sheets of monochrome print of printed paper size as the charging information, and proceeds to step S1-35.

In step S1-31, the charging information collection unit 25 (FIG. 3) increases by one the number of error sheets of multicolor print of printed paper size as the charging information, and proceeds to step S1-35.

In step S1-32, the charging information collection unit 25 (FIG. 3) determines whether the printing process is multicolor. In a case of multicolor print, it is proceeded to step S1-33. In a case of monochrome print, it is proceeded to step S1-34.

In step S1-33, the charging information collection unit 25 (FIG. 3) increases by one the number of normal sheets of multicolor print of printed paper size as the charging information, and proceeds to step S1-35.

In step S1-34, the charging information collection unit 25 (FIG. 3) increases by one the number of normal sheets of monochrome print of printed paper size as the charging information, and proceeds to step S1-35.

In step S1-35, the charging information collection unit 25 (FIG. 3) determines whether or not printing is finished or interrupted at this sheet. In a case where printing is finished or interrupted at this sheet, it is proceeded to step S1-36. In the other cases, it is repeated from step S1-21 until printing is either finished or interrupted.

In step S1-36, the charging information collection unit 25 (FIG. 3) transmits the collected charging information to the charging server 120 (FIG. 1) via the communication unit 21 (FIG. 3) through the network 130. Subsequently, the charging server 120 (FIG. 1) having received the collected charging information executes the above mentioned steps S1-13 through S1-16. The user computers 100-1 through 100-3 having received the collected charging information and the charging amount calculated by the charging server 120 (FIG. 1) receive the charging amount notification at step S1-5 (FIG. 6).

As described above, with the image forming apparatus according to the first embodiment, the number of the print media wasted because of a reason that users are not responsible for such as paper jamming is not included in the consumed amount, and thus, charging can be performed fairly thanks to the event recognition unit for interrupting the printing process upon detecting an occurrence of paper jamming and as such in the midway through the printing process and a charging information collection unit, being able to recognize amounts of consumable supplies consumed by the printing process and amounts of consumable supplies wasted by paper jamming and as such, which collects usage amounts of each type of the consumable supplies consumed by the printing process and usage amounts of each type of the consumable supplies wasted by paper jamming and as such upon an interruption of the printing process.

The second embodiment according to this invention is hereinafter described. The second embodiment enables the user to give a print cancel instruction (a print interruption command) after the user has transmitted a set of print data (a print job) from the user computer, and enables the charging amount to include charging for a sheet in the midway of which the print cancel instruction has canceled printing.

A system configuration of an image forming apparatus according to the second embodiment is omitted as being the same as the first embodiment except that the reference numerals of the user computers 100-1 through 100-3 are changed to user computers 200-1 through 200-3, those of the image forming apparatus 110 are changed to an image forming apparatus 210, and that of the charging server 120 is changed to a charging server 220, respectively. Only the difference is hereinafter described in detail that distinguishes the user computer 200, the image forming apparatus 210, and the charging server 220 from their counterparts of the first embodiment. Similar units as the first embodiment are denoted by the same reference numerals as the first embodiment, and the description thereof is omitted.

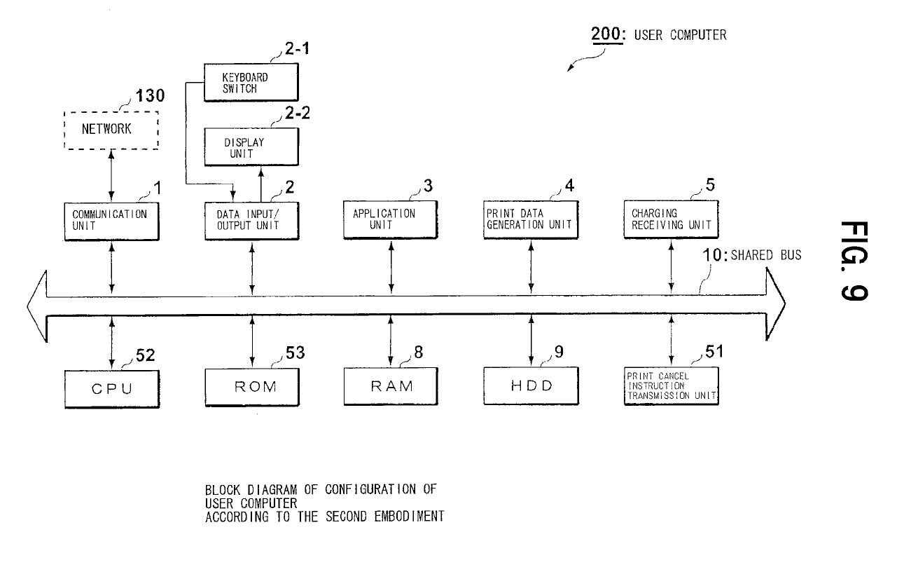

FIG. 9 is a block diagram showing a configuration of the user computer according to the second embodiment. As shown in FIG. 9, the user computer 200 according to the second embodiment includes a communication unit 1, the data input/output unit 2, the application unit 3, the print data generation unit 4, the charging receiving unit 5, a CPU 52, a ROM 53, a RAM 8, a HDD 9, a shared bus 10, and a print cancel instruction transmission unit 51. The user computer 200 is an apparatus: with which a user inputs a desired print information; which receives and notifies the user of a charging amount of consumable supplies consumed upon printing the print information input by the user; and which notifies the user of the charging amount including charging for a sheet in the midway of which a printing process is canceled where the image forming apparatus 210 interrupts printing the print information input by the user in the midway through its printing. The user computer 200 is usually a personal computer.

The print cancel instruction transmission unit 51 is a unit to generate a print job for instructing print cancel (print interruption) and transmit the print job to the image forming apparatus via the communication unit 1, the network, and the charging server. This performance is realized with the CPU 52 executing the control program previously stored in the ROM 53 or the HDD 9.

The CPU 52 is a microprocessor for controlling the entire apparatus, and more particularly in the second embodiment, the CPU 52 not only initiates but also executes the application unit 3, the print data generation unit 4, the charging receiving unit 5, and the print cancel instruction transmission unit 51 by executing a control program previously stored in the ROM 53 or the HDD 9.

The ROM 53 is a read-only memory previously storing the control program for controlling the entire apparatus, and more particularly in the second embodiment, the ROM 53 is a read-only memory previously storing the control program that the CPU 52 executes for initiating the application unit 3, the print data generation unit 4, the charging receiving unit 5, and the print cancel instruction transmission unit 51.

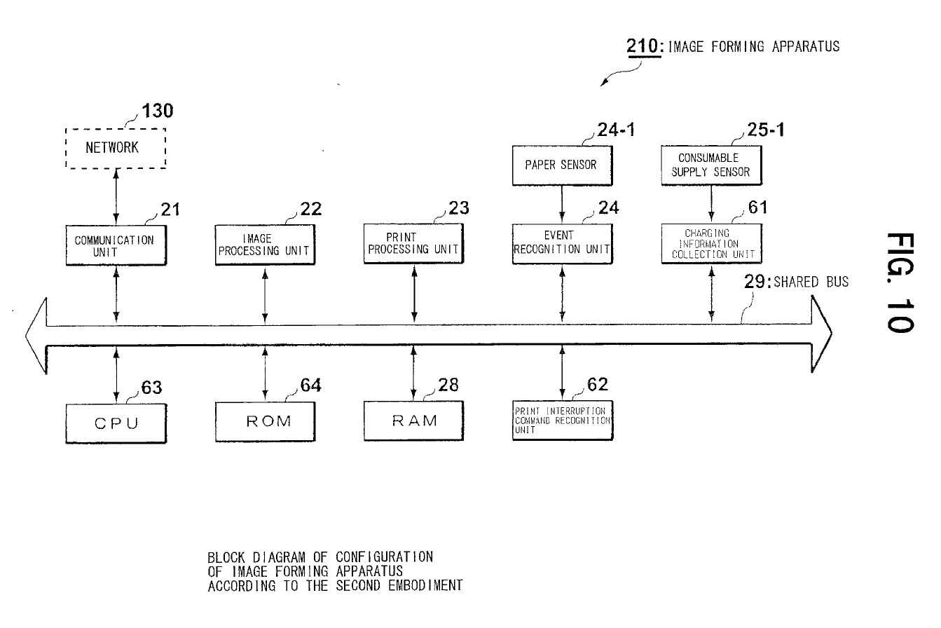

FIG. 10 is a block diagram showing a configuration of the image forming apparatus according to the second embodiment. As shown in FIG. 10, the image forming apparatus 210 according to the second embodiment includes the communication unit 21, the image process unit 22, a printing process unit 23, the event recognition unit 24, a charging information collection unit 61, a CPU 63, a ROM 64, a RAM 28, a shared bus 29, and a print interruption command recognition unit 62. The image forming apparatus 210 is a printing apparatus for receiving print information input by the user with the user computers 200-1 through 200-3 and performing printing process, for collecting and notifying the charging server 220 of usage amounts and types of consumable supplies consumed by printing the print information input by the user, and for interrupting printing the print job in the midway through printing process and collecting and notifying the charging server 220 of usage amounts and types of consumable supplies consumed until then.

The charging information collection unit 61 receives the usage amounts and types of consumable supplies consumed by the printing process from the consumable supply sensor arranged at the prescribed position of the printing process unit 23 to collect the charging information and notifies the charging server 220 thereof via the network, where the printing process for the set of print request (the print job) received from any one of the user computers 200-1 through 200-3 has been either finished or interrupted. This performance is realized with the CPU 63 executing the control program previously stored in the ROM 64 upon extracting it to the RAM 28.

The CPU 63 is a microprocessor for controlling the entire apparatus, and more particularly in the second embodiment, the CPU 63 realizes functions of the image process unit 22, the event recognition unit 24, the charging information collection unit 61, and the print interruption command recognition unit 62 by executing a control program previously stored in the ROM 64.

The ROM 64 is a read-only memory previously storing the control program for controlling the entire apparatus, and more particularly in the second embodiment, the ROM 64 is a read-only memory previously storing the control program that the CPU 63 executes for realizing the functions of the image process unit 22, the event recognition unit 24, the charging information collection unit 61, and the print interruption command recognition unit 62.

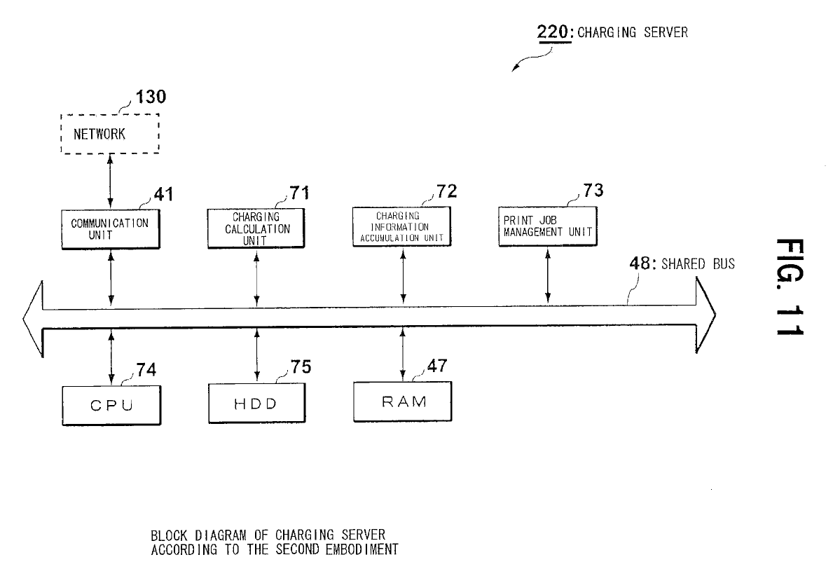

FIG. 11 is a block diagram showing a configuration of the charging server according to the second embodiment. As shown in FIG. 11, the charging server 220 according to the second embodiment includes the communication unit 41 serving as an input unit, a charging calculation unit 71, a charging accumulation unit 72, the print job management unit 73, a CPU 74, a HDD 75, the RAM 47, and the shared bus 48. The charging server 220 is a server through which the user transmits print data to the image forming apparatus 210 from the user computers 200-1 through 200-3 and which collects from the image forming apparatus 210 the accumulated result of usage amounts and types of consumable supplies consumed by printing the print data to notify each of the user computers 200-1 through 200-3 of a calculated charging amount. Furthermore, where the charging server 220 receives the print job including the interruption command from the user computers 200-1 through 200-3, the charging server 220 not only instructs the image forming apparatus 210 to interrupt printing the corresponding print job but also collects from the image forming apparatus 210 the accumulated result of usage amounts and types of consumable supplies consumed until then to notify each of the user computers 200-1 through 200-3 of a calculated charging amount.

The charging calculation unit 71 receives from the image forming apparatus (FIG. 10) the accumulated result of usage amounts and types of consumable supplies consumed by printing the set of print data (the print job) and calculates the charging amount, when the printing process for the set of print data (the print job) has been either finished or interrupted. The charging calculation unit 71 calculates the charging amount including charging for a sheet in the midway of which a printing process is canceled. This performance is realized with the CPU 74 executing the control program previously stored in the HDD 75.

The charging accumulation unit 72 accumulates in a charging accumulation table, for each user computer respectively, the accumulated result of usage amounts and types of consumable supplies consumed by printing the print information input by the user with the user computer 200 and charging amounts calculated by the charging calculation unit 71. This performance is realized with the CPU 74 extracting the control program previously stored in the HDD 75 to the RAM 47 and executing the program.

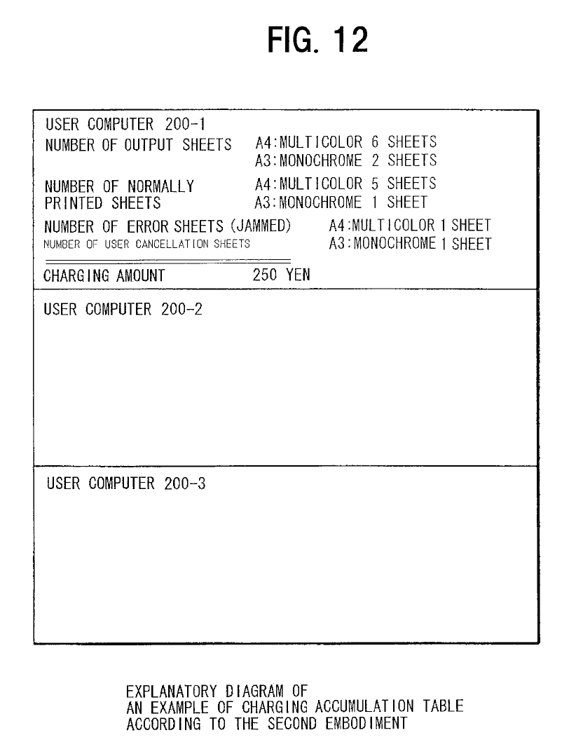

FIG. 12 is an explanatory diagram showing an example of the charging accumulation table according to the second embodiment. As shown in FIG. 12, displayed is the accumulated result of usage amounts, namely, the number of output sheets, the number of normally printed sheets, the number of error sheets, the number of sheets wasted due to the user's cancellation, and a calculated charging amount for each user computer. Information within a frame for each user computer in the table is revised when the printing process for the set of print request (the print job or the successive series of print jobs) received from the user computers has been either finished or interrupted.

Referring back to FIG. 11, the print job management unit 73 is a unit through which the user transmits the print data from the user computer 200 to the image forming apparatus 210 (FIG. 10) and which manages the print job including the print data, namely, e.g., determining whether the set of the print request includes only a single print job or a successive series of multiple print jobs and determining a printing sequence of the print jobs. This performance is realized with the CPU 74 extracting the control program previously stored in the HDD 75 to the RAM 47 and executes it.

The CPU 74 is a microprocessor for controlling the entire apparatus, and more particularly in the second embodiment, the CPU 74 realizes functions of the charging calculation unit 71, the charging accumulation unit 72, and the print job management unit 73 by extracting a control program previously stored in the HDD 75 to the RAM 47 and executing the program.

The HDD 75 is a hard disk previously storing the control program for controlling the entire apparatus, and more particularly in the second embodiment, the HDD 75 is a hard disk previously storing the control program that the CPU 74 executes for realizing functions of the charging calculation unit 71, the charging accumulation unit 72, and the print job management unit 73.

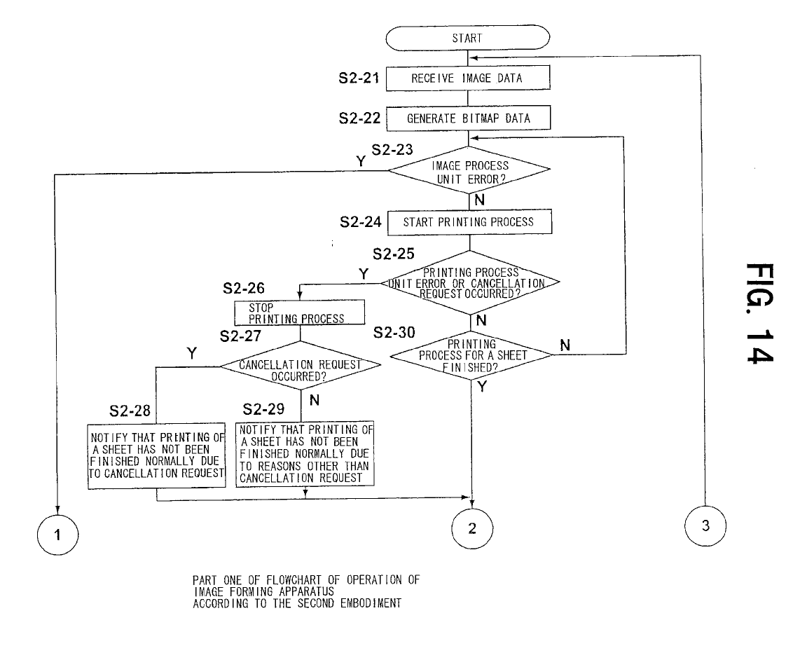

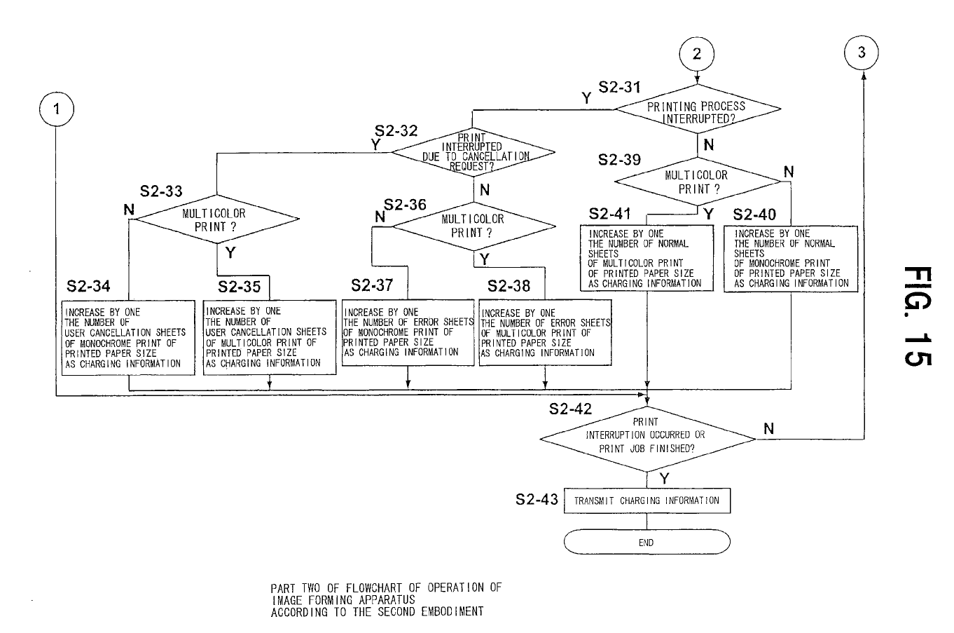

An operation of second embodiment is hereinafter described in detail. First, an operation of the user computer 200 (FIG. 9) is described, and subsequently an operation of the charging server 210 (FIG. 10) is described. An operation of the charging server 220 (FIG. 11) is omitted as being similar to the first embodiment (FIG. 7). However, steps S1-21 through S1-36 (FIG. 8) inserted at step S1-13 in FIG. 7 of the first embodiment are replaced, in the second embodiment, with steps S2-21 through S2-43 in FIG. 14 and FIG. 15, which will be described below.

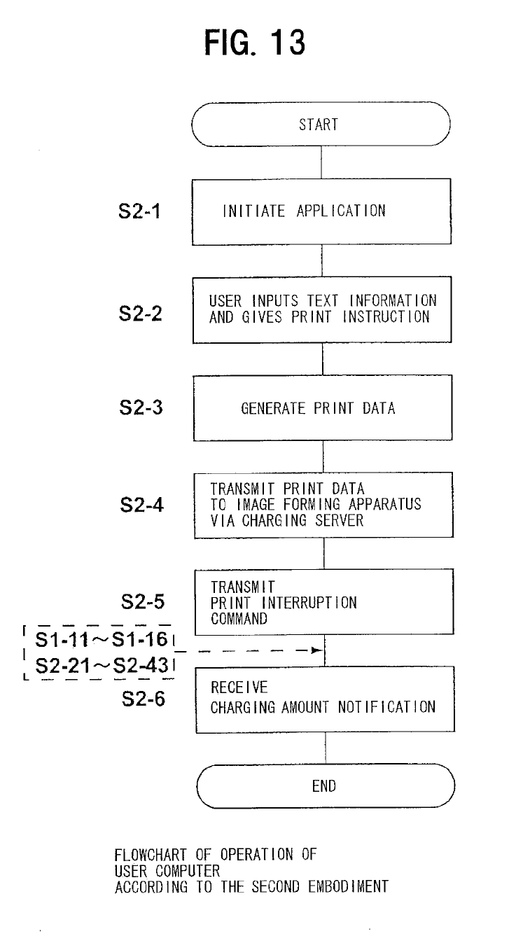

FIG. 13 is a flowchart showing an operation of the user computer according to the second embodiment. An operation of the user computer for steps S2-1 through S1-6 is hereinafter described in a sequence of steps.

In step S2-1, the user initiates the application unit 30 (FIG. 9) by the use of the keyboard switch 2-1 (FIG. 9) and the display unit 2-2 (FIG. 9).

In step S2-2, the user inputs the print information by the use of the keyboard switch 2-1 (FIG. 9) and the display unit 2-2 (FIG. 9), and gives a print instruction from the application unit 30 (FIG. 9).

In step S2-3, the print data generation unit 4 (FIG. 9) generates the print data (namely, the print data) based on the print information input with the data input/output unit 2 (FIG. 9) upon a print instruction from the application unit 30 (FIG. 9).

In step S2-4, the communication unit 1 (FIG. 9) transmits the print data generated by the print data generation unit 4 (FIG. 9) through the network via the charging server 120 (FIG. 11) to the image forming apparatus 210 (FIG. 10).

In step S2-5, where the user inputs the print interruption command into the data input/output unit 2 with the use of the keyboard switch 2-1 (FIG. 9) and the display unit 2-2 (FIG. 9), the application unit 30 (FIG. 9) generates a command including the print interruption command, which is transmitted to the image forming apparatus 210 (FIG. 10) via the charging server 220 (FIG. 11).

In step S2-6, the charging receiving unit 5 (FIG. 9) terminates this flow upon receiving the charging amount notification from the charging server 120 (FIG. 11) and notifying the user of the charging amount with the display unit 2-2 (FIG. 9) after steps S1-11 through S1-16 (the flowchart for the charging server according to the second embodiment is the same as that according to the first embodiment) and step S2-21 through S2-42 have been performed, as described below.

Please note that steps S2-21 through S2-42 cause an amount wasted due to an interruption command of the user to be included in the charging amount. Therefore, in step S1-14, the charging calculation unit 71 (FIG. 11) calculates the charging amount (the charging information) based on the accumulated result of usage amounts and types of consumable supplies as a following example. Suppose a case that the user requests a print job of ten sheets of A4 size and a print job of three sheets of A3 size, and that paper jamming occurs at sixth sheet of A4 size and the user enters the print interruption command at the second sheet of A3 size, thus resulting in a final out put of five sheets of A4 size and two sheets of A3 size, the charging amount is calculated as follows. Suppose that 20 Yen for A4 and 50 Yen for A3 are charged per normally printed sheet no matter whether multicolor or monochrome.
The charging amount (Yen)=20(Yen)×5(Sheets)+50(Yen)×3(Sheets)=250(Yen)
Please note that a sheet of A4 size wasted due to an unfavorable phenomenon (paper jamming) is deleted from the six sheets of A4 and three sheets of A3 consumed by the printing process, and that a sheet of A3 size wasted due to the print interruption command is included as it is.

FIG. 14 is part 1 of a flowchart showing an operation of the image forming apparatus according to the second embodiment.

FIG. 15 is part 2 of a flowchart showing an operation of the image forming apparatus according to the second embodiment.

An operation of the image forming apparatus 210 (FIG. 10) for steps S2-21 through S2-43 is hereinafter described in a sequence of steps.

In step S2-21, the communication unit 21 (FIG. 10) receives the print data from the user computer 200 (FIG. 9) through the network via the charging server 220 (FIG. 11).

In step S2-22, the image process unit 22 (FIG. 10) receives the print data from the communication unit 21 (FIG. 21) and extends them into bitmap data on the RAM 28 (FIG. 10).

In step S2-23, where the image process unit error occurs, namely, e.g., a control code that the image process unit 22 (FIG. 10) cannot interpret is included, processing of the print job is terminated here, and it is proceeded to step S2-42. Where no image process unit error occurs, it is proceeded to step S2-24.

In step S2-24, the printing process unit 23 (FIG. 10) receives the bitmap data from the RAM 28 (FIG. 10) and starts the printing process.

In step S2-25, the event recognition unit 24 (FIG. 10) determines whether the printing process unit 23 (FIG. 10) recognizes an occurrence of paper jamming (the printing process unit error) and whether the print interruption command recognition unit 62 (FIG. 10) recognizes an occurrence of print cancellation (reception of the print interruption command). In a case that at least one occurrence of the above is recognized, it is proceeded to step S2-26. In a case that no occurrence of the above is recognized, it is proceeded to step S2-30.

In step S2-26, the event recognition unit 24 (FIG. 10) or the print interruption command recognition unit 62 (FIG. 10) interrupts the printing process, and it is proceeded to step S2-27.

In step S2-27, where the print interruption command recognition unit 62 (FIG. 10) recognizes the occurrence of the print cancellation (the print interruption command), it is proceeded to step S2-28. Where the event recognition unit 24 (FIG. 10) recognizes the occurrence of the paper jamming (the printing process unit error), it is proceeded to step S2-29.

In step S2-28, the print interruption command recognition unit 62 (FIG. 10) notifies the charging information collection unit 61 (FIG. 10) that a cancellation request has caused printing a sheet to be useless in the midway through printing, and proceeds to step S2-31.

In step S2-29, the event recognition unit 24 (FIG. 10) notifies the charging information collection unit 61 (FIG. 10) that the occurrence of the paper jamming caused printing of a sheet failing to finish normally, and proceeds to step S2-31.

In step S2-30, the printing process unit 23 (FIG. 10) repeats steps S2-23 through S2-30 until printing of a sheet finishes, and proceeds to step S2-31 upon finishing printing of a sheet.

In step S2-31, where the printing process is interrupted (namely, in a case of having performed step S2-26), it is proceeded to step S2-32. Where the printing process has finished printing a sheet (namely, in a case of having performed step S2-30), it is proceeded to step S2-39.

In step S2-32, where the printing process is interrupted due to the cancellation request (the print interruption command), it is proceeded to step S2-33. Where the printing process is interrupted due to the occurrence of the paper jamming, it is proceeded to step S2-36.

In step S2-33, the charging information collection unit 61 (FIG. 10) determines whether the printing process is multicolor print. In a case of monochrome print, it is proceeded to step S2-34. In a case of multicolor print, it is proceeded to step S2-35.

In step S2-34, the charging information collection unit 61 (FIG. 10) increases by one the number of user cancellation sheets of monochrome print of printed paper size as the charging information, and proceeds to step S2-42.

In step S2-35, the charging information collection unit 61 (FIG. 10) increases by one the number of user cancellation sheets of multicolor print of printed paper size as the charging information, and proceeds to step S2-42.

In step S2-36, the charging information collection unit 61 (FIG. 10) determines whether the printing process is multicolor print. In a case of monochrome print, it is proceeded to step S2-37. In a case of multicolor print, it is proceeded to step S2-38.

In step S2-37, the charging information collection unit 61 (FIG. 10) increases by one the number of error sheets of monochrome print of printed paper size as the charging information, and proceeds to step S2-42.

In step S2-38, the charging information collection unit 61 (FIG. 10) increases by one the number of error sheets of multicolor print of printed paper size as the charging information, and proceeds to step S2-42.

In step S2-39, the charging information collection unit 61 (FIG. 10) determines whether the printing process is multicolor print. In a case of monochrome print, it is proceeded to step S2-40. In a case of multicolor print, it is proceeded to step S2-41.

In step S2-40, the charging information collection unit 61 (FIG. 10) increases by one the number of normal sheets of monochrome print of printed paper size as the charging information, and proceeds to step S2-42.

In step S2-41, the charging information collection unit 61 (FIG. 10) increases by one the number of normal sheets of multicolor print of printed paper size as the charging information, and proceeds to step S2-42.

In step S2-42, the charging information collection unit 61 (FIG. 10) determines whether or not printing is finished or interrupted at this sheet. In a case where the printing is finished or interrupted at this sheet, it is proceeded to step S2-43. In the other cases, it is repeated from step S2-21 until the printing is finished or interrupted.

In step S2-43, the charging information collection unit 61 (FIG. 10) transmits the collected charging information to the charging server 220 (FIG. 11) via the communication unit 21 (FIG. 10) through the network 130. Subsequently, the charging server 220 (FIG. 11) having received the collected charging information executes the above mentioned steps S1-13 through S1-16 (FIG. 7). The user computer 200 having received the collected charging information and the charging amount calculated by the charging server 220 (FIG. 11) receives the charging amount notification at step S2-6 (FIG. 13).

As hereinabove described, the image forming apparatus according to the second embodiment enables fairer charging than that according to the first embodiment because the second embodiment enables the usage amount to include the number of print media wasted due to the interruption command executed at the responsibility of the user. The image forming apparatus according to the second embodiment includes the print interruption command recognition unit for receiving the interruption command in the midway through the printing process and the charging information collection unit for collecting the usage amounts for each type of consumable supplies wasted due to the interruption command. That is, the image forming apparatus according to the second embodiment can charge the user for consumed consumable supplies such as paper where the user cancels a printing process after the printing process has begun printing a sheet, and thus making it possible to charge the user for expenses incurred by himself.

In both of those two embodiments as described above, it is supposed that bitmap data generation from the print data and the printing process at a print unit are performed sequentially. However, it may also be configured in such a manner that receiving of the print data, the bitmap data generation, and the printing process are performed in parallel. Furthermore, in the second embodiment, the printing process is interrupted in the midway through printing a sheet for the purpose of clarifying an occurrence of the print interruption caused by a cancellation request of the user in the midway through printing a sheet. However, it may also be configured to print something on a sheet indicating a cancellation caused by the user such as, e.g., “user cancellation occurred”.

In both of those two embodiments as described above, the charging server receives the charging information from the image forming apparatus via the network. However, the image forming apparatus may have an output unit other than the communication unit for outputting the charging information, so that the charging server is enabled to receive the charging information that is output from the output unit either directly or via various memory media such as, e.g., USB memory and SD-RAM without the use of the network. In such a case, the print data is directly transmitted to the image forming apparatus, whereas the charging amount notification is sent to users via a way other than the network.

In the above description, described are cases for applying this invention to a printer, however, this invention is not limited to those embodiments. That is, this invention can be applied to facsimiles, photocopiers, and as such.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An image forming apparatus for collecting a usage amount of a consumable supply consumed by a printing process for each requesting source of said printing process, said image forming apparatus comprising:
an event recognition unit for interrupting said printing process upon detecting a prescribed condition during said printing process; and
a charging information collection unit for collecting the usage amount of said consumable supply consumed by said printing process interrupted by said event recognition unit.

2. The image forming apparatus according to claim 1, wherein said prescribed condition occurs according to a status of said image forming apparatus.

3. The image forming apparatus according to claim 1, wherein said prescribed condition occurs according to a status of said image forming apparatus and to a user's request.

4. The image forming apparatus according to claim 1, wherein said consumable supply includes a recording medium and a developer.

5. The image forming apparatus according to claim 1 further comprising an output unit for outputting the usage amount to a memory medium.

6. The image forming apparatus according to claim 1, wherein said charging information collection unit further collects a type of said consumable supply consumed by said printing process interrupted by said event recognition unit.

7. A charging process apparatus comprising:
an input unit for receiving a first consumable supply usage amount consumed by a printing process and a second consumable supply usage amount consumed by a printing process interrupted; and
a charging calculation unit for calculating a charging amount based on said first consumable supply usage amount and said second consumable supply usage amount received from said input unit.

8. The charging process apparatus according to claim 6, wherein said consumable supply includes a recording medium and a developer.

9. The charging process apparatus according to claim 6, wherein said input unit receives said first consumable supply usage amount and said second consumable supply usage amount via a memory medium.

10. The charging process apparatus according to claim 6, wherein said input unit further receives information indicating a prescribed condition being a ground for interrupting the printing process, and wherein said charging calculation unit calculates the charging amount based on said first consumable supply usage amount, said second consumable supply usage amount, and said information indicating the prescribed condition.

11. The charging process apparatus according to claim 9, wherein said prescribed condition occurs according to a status of said image forming apparatus and to a user's request.

12. An image forming system comprising:
an image forming apparatus for collecting a usage amount of a consumable supply consumed by a printing process for each requesting source of said printing process, said image forming apparatus having an event recognition unit for interrupting said printing process upon detecting a prescribed condition during said printing process and a charging information collection unit for collecting a usage amount of the consumable supply consumed by said printing process interrupted by said event recognition unit; and
a charging process apparatus having an input unit for receiving from said image forming apparatus a first consumable supply usage amount consumed by the printing process and a second consumable supply usage amount consumed by said printing process interrupted and a charging calculation unit for calculating a charging amount based on said first consumable supply usage amount and said second consumable supply usage amount received from said input unit.

13. The image forming system according to claim 11, wherein said prescribed condition occurs according to a status of said image forming apparatus.

14. The image forming system according to claim 11, wherein said image forming apparatus further has an output unit for outputting the usage amount of the consumable supply to a memory medium, and wherein said input unit receives said first consumable supply usage amount and said second consumable supply usage amount via said memory medium.

15. The image forming system according to claim 11, wherein said input unit of said charging process apparatus further receives information indicating said prescribed condition, and wherein said charging calculation unit of said charging process apparatus calculates the charging amount based on said first consumable supply usage amount, said second consumable supply usage amount, and said information indicating said prescribed condition.

16. The image forming system according to claim 11, wherein said prescribed condition occurs according to a status of said image forming apparatus and a user's request.
